(19) United States
(12) Patent Application Publication
(10) Pub. No.: US 2004/0162581 A1
(43) Pub. Date: Aug. 19, 2004

(54) Nursery care article intended for suction by an infant

(76) Inventor: Pierre Grasset, Saint Vidal (FR)

Correspondence Address: DOWELL & DOWELL PC, SUITE 309, 1215 JEFFERSON DAVIS HIGHWAY, ARLINGTON, VA, 22202

(21) Appl. No.: 10/773,260

(22) Filed: Feb. 9, 2004

(30) Foreign Application Priority Data
Feb. 13, 2003 (FR) 03 01747

(51) Int. Cl. A61J 17/00

(52) U.S. Cl. 606/234

(57) ABSTRACT

This article for nursery care, which is in particular a feeding bottle or a comforter, comprises a body, a tip for suction intended to penetrate at least partially in an infant's mouth, as well as a member on which the infant's lips abut during such suction.

The hardness of the member on which the lips abut is clearly greater than the hardness of the tip, with the result that suction is effected physiologically, simulating breast-feeding.

### FIELD OF THE INVENTION

The present invention relates to an article for nursery care, intended for suction by an infant.

### BACKGROUND OF THE INVENTION

Within the meaning of the invention, such an article for nursery care is provided in particular with a tip for suction, intended to penetrate in an infant's mouth. By way of non-limiting example, it is question of a feeding bottle, or a comforter.

In the case of a feeding bottle, the latter conventionally comprises a body, for example made of plastics material, intended to receive a liquid for feeding the infant, particularly milk. This body is surmounted by a supple teat, provided with the afore-mentioned tip element for suction.

This teat and this body are mutually connected via a tapped ring, also called screwed ring. To that end, the latter cooperates with an outer thread made on the upper part of the body.

In the case of a comforter, the latter conventionally comprises a body, also called shield, on which the afore-mentioned tip element for suction is mounted.

It is an object of the present invention to provide an article for nursery care of the type described hereinabove, which makes it possible to simulate breast-feeding more satisfactorily than those developed up to the present time in the prior art.

### SUMMARY OF THE INVENTION

To that end, the present invention relates to an article for nursery care, in particular a feeding bottle or comforter, comprising a body, a tip for suction intended to penetrate at least partially in an infant's mouth, as well as a member on which the infant's lips abut during suction, characterized in that the hardness of the member on which the lips abut is clearly greater than the hardness of the tip.

### BRIEF DESCRIPTION OF THE DRAWINGS

The invention will be more readily understood on reading the following description given solely by way of non-limiting example, with reference to the accompanying drawings, in which:

FIG. 1 is a view in longitudinal section, illustrating a feeding bottle according to the invention.

FIG. 2 is a view in longitudinal section, similar to FIG. 1, illustrating a variant embodiment of the bottle of FIG. 1.

FIG. 3 is a view in longitudinal section, illustrating a teat belonging to a feeding bottle in accordance with another variant embodiment of the invention; and

FIG. 4 is a front view, illustrating a comforter for infant according to the invention.

### DESCRIPTION OF PREFERRED EMBODIMENTS

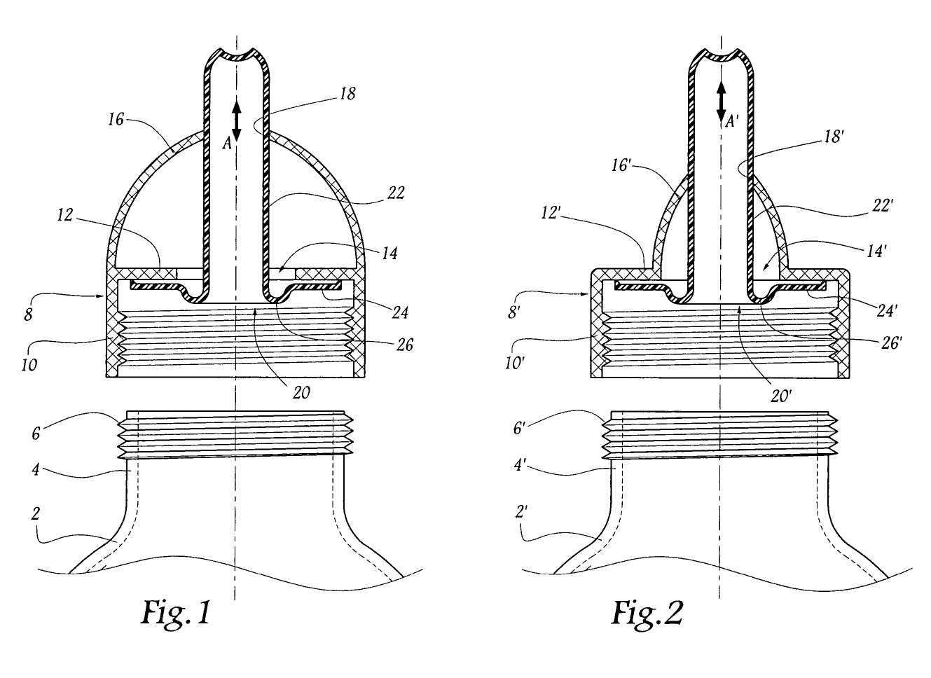

Referring now to the drawings, the feeding bottle of FIG. 1 comprises a body 2, shown only partially, which conventionally presents an upper neck 4 provided with a threading 6. This feeding bottle is also provided with a ring 8 which comprises a cylindrical principal part 10, of which the inner wall is tapped, so as to cooperate with the threading 6.

This principal part 10 extends, at one of its ends, in a re-entrant flange 12, defining a central opening 14. A skirt 16, moulded therewith, extends axially from the outer periphery of the flange 12.

This skirt 16 tapers opposite the principal part 10, with the result that its free end defines a central orifice 18, which is coaxial to the afore-mentioned opening 14, while presenting transverse dimensions smaller than the latter.

The ring 8 and the skirt 16 are made of a material presenting a certain hardness, for example higher than 50 Shore A. By way of non-limiting example, such a material is polypropylene.

The feeding bottle of FIG. 1 also comprises a teat 20, which comprises an elongated cylindrical tip 22, of which the outer dimensions correspond substantially to the inner dimensions of the central orifice 18. This teat 20 is also provided with a flange 24, intended to abut beneath the flange 12 of the ring 8.

Finally, a peripheral zone 26 is provided, ensuring the join between the tip 22 and the flange 24. The concavity of this zone 26 faces upwardly, which makes it possible to facilitate the movement of the tip 22, along its principal axis A, with respect to the flange 24.

The teat 20 is made of a material presenting a hardness lower than that of the ring 8 and of the skirt 16, namely included for example between 20 and 50 Shore A, and particularly close to 40 Shore A. The material constituting the tip is for example silicone or rubber.

Functioning of the feeding bottle of FIG. 1 will now be described.

Firstly, the flange 24 of the teat 20 is arranged below the flange 12 of the ring 8. Consequently, said flange 24 can be wedged between said flange 12 and the neck 4, once the body 2 and the ring 8 have been mutually connected.

Furthermore, in the position of use of the bottle, illustrated in FIG. 1, the tip 22 of the teat 20 penetrates through the orifice 18, defined by the end of the skirt 16. During sucking, the infant's lips abut on the skirt 16, while the tip 22 penetrates at least partially into this infant's mouth.

This tip is then subjected to suction, via the infant's tongue and palate.

Such suction is in particular physiological, being given that the tip 22 is independent of the skirt 16. In effect, this tip can move along its principal axis A, without inducing substantial movement of the skirt.

This physiological nature is reinforced by the fact that the tip 22 and the skirt 16 are made of materials presenting different hardnesses.

Consequently, when in use, the skirt 16 ensures a function of abutment of the infant's lips, so as to simulate the maternal areola. Furthermore, the tip 22, which is more supple and has a possibility of axial displacement, simulates the maternal nipple.

This is to be compared with feeding bottles of conventional type, in which the skirt and the tip are integral, presenting the same hardness. Such known teats are therefore not physiological, being given that suction thereof differs fundamentally from breast feeding.

FIG. 2 illustrates a variant embodiment of the feeding bottle shown in FIG. 1. The mechanical elements of this FIG. 2 are allocated the same references as those of FIG. 1, to which a “prime” has been added.

The body 2′ of the feeding bottle of FIG. 2, as well as teat 20′, are identical to those, 2 and 20, of FIG. 1. The only difference lies in the form of the skirt 16′, of which the tapering end extends from the inner periphery of the flange 12′.

This skirt 16′, which presents overall dimensions smaller than those of the skirt 16 of FIG. 1, likewise defines at its free end an orifice 18′, through which the teat 20′ penetrates. The feeding bottle of this FIG. 2 functions in all respects like that described with reference to FIG. 1.

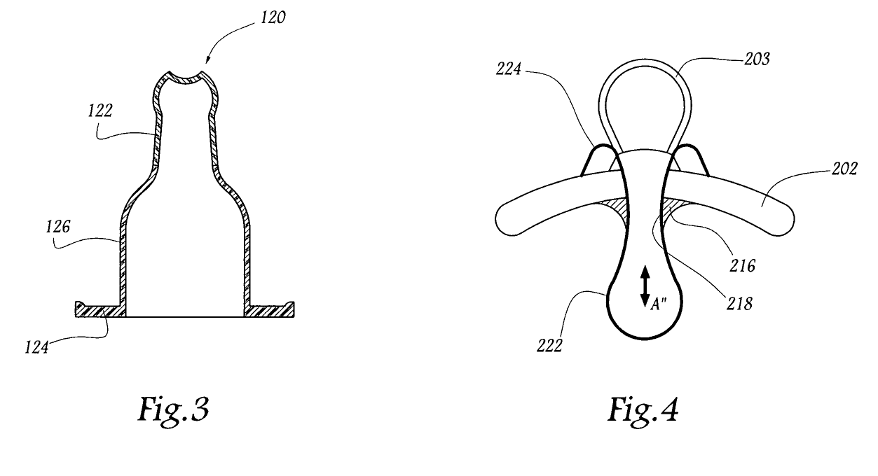

FIG. 3 illustrates a teat 120 which comprises a flange 124, extended by a skirt 116, which terminates in a tip 122. This teat may be connected conventionally on a bottle body (not shown), by means of a screw ring likewise not shown.

This teat, which is for example made by a bi-injection operation, presents two different hardnesses. For example the tip 122 presents a hardness lower than that of the skirt 116, and therefore than that of the flange 124.

More precisely, the tip 12, which is particularly made of a first type of silicone, presents a hardness included for example between 20 and 50 Shore A. Furthermore, the skirt 116, which is particularly made of another type of silicone, presents a hardness higher for example than 50 Shore A.

In use, the infant's lips abut on the skirt 116, which is relatively firm. Furthermore, the infant effects a suction of the tip, which is more supple and consequently more malleable than said skirt.

Consequently, such suction is effected in physiological manner, which enables breast-feeding to be satisfactorily simulated.

FIG. 4 illustrates a comforter for infant, according to the invention.

This comforter comprises a body 202, also called shield, which supports a ring 203. This body is provided, opposite the ring 203, with a boss 216 moulded therewith.

The body 202 and the boss 216, which are particularly made of polypropylene, present a certain hardness which is higher for example than 50 Shore A.

A central orifice 218 is provided, made both in the boss 216 and the body 202. This orifice receives a tip 222 which is extended by a flange 224, connected to the body 202 by any appropriate means, opposite the boss 216.

This tip 222, which is for example made of silicone, presents a hardness clearly lower than that of the body 202 and of the boss 216. Thus the hardness of this tip 222 is for example included between 20 and 50 Shore A.

In use, the infant's lips abut on the boss 216 while a suction is effected on the tip 222. This is a particularly physiological action, being given that the tip 222 is independent of the boss 216 where the lips abut, along its principal axis A″, and that these two elements present different hardnesses.

As set forth hereinabove with reference to the feeding bottle of FIGS. 1 and 2, the boss 216 and the tip 222 thus respectively simulate the maternal areola and nipple, with the result that, by sucking this comforter, the infant is reminded of breast-feeding.

What is claimed is:

1. Nursery care article, in particular a feeding bottle or comforter, comprising a body, a tip for suction intended to penetrate at least partially in an infant's mouth, as well as a member on which the infant's lips abut during suction,
wherein the hardness of the member on which the lips abut is clearly greater than the hardness of the tip.

2. The article of claim 1, wherein the hardness of the member on which the lips abut is higher than 50 Shore A.

3. The article of claim 1, wherein the hardness of the tip is included between 20 and 50 Shore A.

4. The article of claim 1, wherein the member on which the lips abut and the tip are integral, particularly in that they are made by bi-injection.

5. The article of claim 1, wherein it is question of a feeding bottle, the tip and the member on which the lips abut belonging to a teat of this bottle.

6. The article of claim 1, wherein the member on which the lips abut and the tip are mutually independent, at least in translation along a principal axis of this tip.

7. The article of claim 6, wherein it is question of a feeding bottle comprising a ring adapted to be connected on the body, the member on which the lips abut being integral with this ring, while the tip belongs to a teat of this bottle, which is adapted to be removably fixed, by wedging, between opposite surfaces of the ring and the body.

8. The article of claim 7, wherein the member on which the lips abut defines, opposite the ring, an orifice for passage of the tip.

9. The article according to claim 7, wherein the teat comprises said tip, a flange for wedging between the ring and the body, as well as a zone for connection between this tip and this flange, whose shape is adapted to facilitate the movement of the tip, along its principal axis, with respect to the flange.

10. The article of claim 6, wherein it is question of a comforter, the member on which the lips abut being integral with the body, while the tip is extended by a flange for fixation on the body, an orifice for passage of the tip being made in the member on which the lips abut.
